(19) United States
(12) Patent Application Publication
(10) Pub. No.: US 2014/0320450 A1
(43) Pub. Date: Oct. 30, 2014

(54) METHOD OF DETECTING TOUCH AND APPARATUS FOR DETECTING TOUCH USING THE SAME

(71) Applicant: Anapass Inc., Seoul (KR)

(72) Inventors: Jong Hwa LEE, Seoul (KR); Ha Sun Song, Seoul (KR); Woo Hyoung Seo, Seoul (KR)

(73) Assignee: Anapass Inc., Seoul (KR)

(21) Appl. No.: 14/259,283

(22) Filed: Apr. 23, 2014

(30) Foreign Application Priority Data
Apr. 25, 2013 (KR) 10-2013-0046243

(51) Int. Cl. G06F 3/044

(52) U.S. Cl. CPC G06F 3/044; G06F 2203/04104
USPC 345/174

(57) ABSTRACT

A touch detecting apparatus includes a signal source configured to generate a variable phase signal including a reference phase signal and an out-of-phase signal that is out of phase with the reference phase signal, a touch panel including a plurality of driving electrodes and a plurality of sensing electrodes, wherein, if the variable phase signal is applied to one of the plurality of driving electrodes, the sensing electrode outputs a touch signal that is modulated using the variable phase signal, a signal conversion circuit unit configured to detect the touch signal modulated using the variable phase signal, and output the touch signal in the form of a voltage signal, a demodulation circuit unit configured to demodulate the signal output from the signal conversion circuit unit using the variable phase signal, and an accumulator configured to accumulatively output the signal output from the demodulation circuit unit.

### CROSS-REFERENCE TO RELATED APPLICATION

This application claims priority to and the benefit of Korean Patent Application No. 10-2013-0046243, filed on Apr. 25, 2013, the disclosure of which is incorporated herein by reference in its entirety.

### BACKGROUND

1. Field of the Invention

The present invention relates to a method of detecting touch and an apparatus for detecting a touch using the same.

2. Discussion of Related Art

Sensing methods used in a touch screen include resistive sensing, surface ultrasonic sensing and capacitive sensing. Capacitive sensing, which allows multiple touches, and provides a superior durability and visibility, is being increasingly adopted as a main input method for portable mobile devices.

A capacitive touch screen is configured to recognize a user's input by sensing a change in capacitance with which capacitive sensors of a touch screen panel are charged due to a user's interference, and such capacitive touch screens are divided into self-capacitive scheme and a mutual-capacitive scheme depending on a method of storing charges. In self-capacitive sensing, a conductor is provided for each capacitive sensor to form a charged surface together with a reference ground surface outside a touch screen panel, while in mutual capacitive sensing, two conductors that form opposite surfaces while serving as a single capacitive sensor are provided on a touch screen panel.

A general self capacitive method uses an X/Y intersection conductor arrangement, and in this case, each capacitive sensor serves as a line sensor, so that only one piece of X-sensing information is obtained from an X-line sensor group and one piece of Y-sensing information is obtained from a Y-line sensor group during touch screen sensing. Accordingly, such a general self capacitive touch screen provides single touch sensing and tracking, but does not support multiple touches. The mutual capacitive sensing also uses an X/Y intersection conductor arrangement, but is different from the self capacitive sensing in that each capacitive sensor is provided on a conductor intersection location in the form of a grid sensor, and a response of each grid sensor is independently sensed during detection of a user's input on a touch screen. Since each grid sensor corresponds to a different X/Y coordinate value, and provides an independent response result, the mutual capacitive touch screen may sense and track multiple touches of a user by extracting user input information from a set of X/Y sensing information provided from the set of X/Y grid sensors.

A configuration of conductors and a sensing method according to a general mutual capacitive touch screen panel are as follows. First electrodes including conductors aligned in one direction and second electrodes including conductors aligned in another direction perpendicular to the first electrodes form a mutual capacitive sensor while a dielectric material is interposed between the first and second electrodes. A capacitance of the sensor is defined as C=∈*a/d when the distance between the two electrodes is d, the area of a charged surface is a and an equivalent permittivity of all the dielectric material between the charged surfaces is ∈. In addition, when the quantity of electric charges stored in the sensor is Q, and the difference in voltages applied to the two electrodes (two charged surfaces) is V, Q=CV. When a user approaches the sensor, interference occurs at an electric field formed between the two electrodes, which prevents charges from being stored in the sensor, and thus reduces the capacitance. Such a reduction in capacitance may be regarded as being due to a change in the equivalent dielectric between the charged surfaces according to a user's contact, but in practice, is caused by reduction in the quantity of charged/stored charges as an electric field between charged surfaces is partially shunted due to the user's contact. When an alternating current (AC) waveform is applied to one side of a charged surface of the sensor by connecting an AC voltage source to the first electrode, a change in the charging quantity (ΔQ=CΔV) occurs with respect to capacitance C that varies with the proximity of the user, and the change in the charging quantity is converted into an electric current or voltage by a read-out circuit connected to the second electrode. In general, the converted information is subject to signal processing, including noise filtering, demodulation, digital conversion, and accumulation, and used for a coordinate tracking algorithm and a gesture recognition algorithm. Such capacitive touch-sensitive panel technology is disclosed in U.S. Pat. No. 7,920,129.

### SUMMARY OF THE INVENTION

When a signal source applies an electric signal to a driving electrode of a touch panel, an electric field flux formed between the driving electrode and a sensing electrode is shunted by an object, and a change in current corresponding to a change in the electric field flux due to the shunt occurs at the sensing electrode. A signal conversion circuit unit connected to the sensing electrode detects the change in current, and determines whether there is a touch from an object. If noise is introduced into an electric current that needs to be detected to determine a touch, the noise exerts influence on detecting information, such as touch coordinates, which leads to errors in the detected coordinates.

Various types of noise may be introduced into a touch panel. For example, when a liquid crystal display (LCD) display is disposed at a lower side of a touch panel, LCD noise due to Vcom of the LCD may have an influence on the touch panel. Introduction of the noise emitted by the LCD display into the touch panel may be minimized by connecting driving electrodes, other than a driving electrode forming an electric field flux by receiving an electric signal, to a low impedance source. In addition, noise may be introduced through an object that applies a touch input. Such noise, which is emitted from a large number of noise sources, for example, a fluorescent lamp or lighting for film-making, may be applied to the panel after being collected by a human body. The above described noise emitted from a common electrode of the LCD may be shielded by the driving electrodes to minimize its effect, but there is no method of shielding the noise introduced through the object.

In addition, noise having a difference in frequency from a signal applied to drive a touch panel is removed through filtering, but noise having the same or a similar frequency with respect to a signal applied to drive a touch panel is not removed through filtering.

According to the conventional technology, touch coordinates are obtained by driving a touch panel using signals having three randomly extracted discrete frequencies, the touch coordinates are computed by the median filtering, in which a maximum value and a minimum value are discharged among the obtained touch coordinates and a medium value is taken, the majority selection filtering, in which the most frequently obtained result is taken among the obtained touch coordinates, or the average selection filtering, in which an average value is calculated with respect to the obtained touch coordinates and used, and based on the computation result, a subsequent process is performed. However, according to such conventional technology, signal processing needs to be performed once for each of the selected signals, and thus power consumption and time of signal processing are increased.

The present invention is directed to a method by which the effect of noise that has the same or similar frequency when compared to a signal to drive a touch panel can be removed or minimized, and a touch panel using the same.

According to an aspect of the present invention, there is provided a touch detecting apparatus comprising: a signal source configured to generate a variable phase signal including a reference phase signal and an out-of-phase signal that is out of phase with the reference phase signal; a touch panel including a plurality of driving electrodes and a plurality of sensing electrodes, wherein the variable phase signal is applied to one of the plurality of driving electrodes, and the sensing electrode outputs a touch signal modulated by the variable phase signal; a demodulation circuit unit configured to demodulate the touch signal modulated by the variable phase signal using the variable phase signal; and an accumulator configured to accumulate the demodulated touch signal to detect the touch.

According to another aspect of the present invention, there is provided A method of detecting touch, the method comprising: generating a variable phase signal including a reference phase signal and an out-of-phase signal that is out of phase with respect to the reference phase signal; applying the variable phase signal to a touch panel and outputting a touch signal modulated by the variable phase signal; demodulating the touch signal modulated by the variable phase signal using the variable phase signal; and accumulating the demodulated touch signal to detect touch.

As described above, the present invention can remove or reduce the effect of noise that has the same or similar frequency as/to that of a signal configured to drive a touch panel and thus is difficult to remove by filtering, by using signals that are out-of phase with each other

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram illustrating construction of a touch detecting apparatus according to an exemplary embodiment of the present invention;

FIG. 2 is a schematic view illustrating a structure of a touch panel;

FIG. 3 is a view explaining terms used in the specification;

FIG. 4 is a schematic view illustrating a variable phase signal, noise and mixed waveforms; and

FIG. 5 is a flowchart showing a method of detecting touch according to an exemplary embodiment of the present invention.

### DETAILED DESCRIPTION OF EXEMPLARY EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein. Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

Meanwhile, terms used in the present invention will be understood as follows.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “contact”, “directly on,” “directly connected to” or “directly coupled to” another element or layer, there are no intervening elements or layers present.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Various embodiments will now be described more fully with reference to the accompanying drawings in which some embodiments are shown. These inventive concepts may, however, be embodied in different forms and should not be construed as limited to the embodiments set forth herein. Rather, these embodiments are provided so that this disclosure is thorough and complete and fully conveys the inventive concept to those skilled in the art. In the drawings, the sizes and relative sizes of layers and regions may be exaggerated for clarity.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

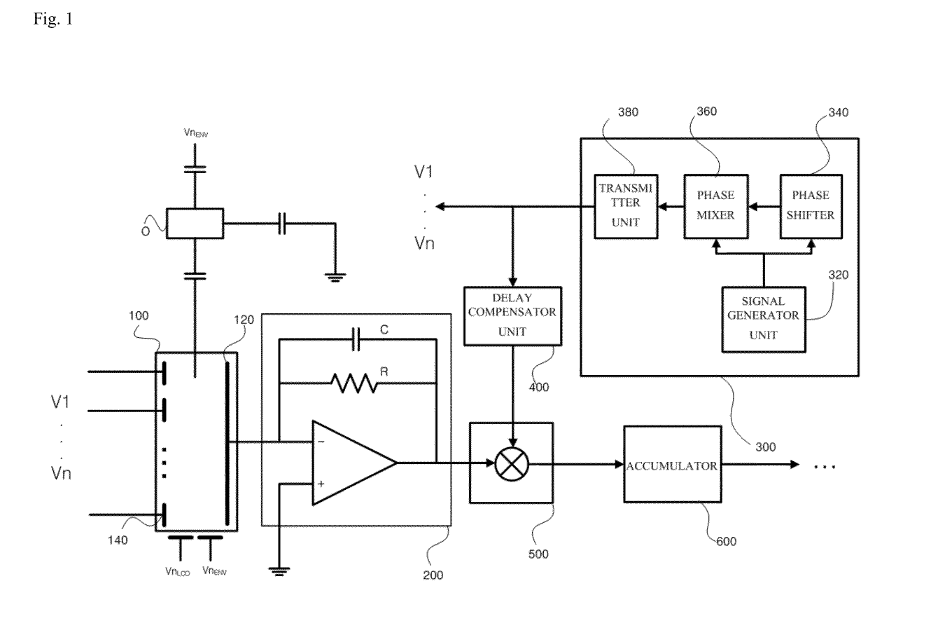

Hereinafter, exemplary embodiments of the present invention will be described. FIG. 1 is a block diagram illustrating construction of a touch detecting apparatus according to an exemplary embodiment of the present invention. The signal source 300 may be configured to generate a variable phase signal including a reference phase signal and an out-of-phase signal that is out of phase with the reference phase signal. The touch panel may include a plurality of driving electrodes and a plurality of sensing electrodes such that one of the sensing electrodes outputs a touch signal that is modulated using the variable phase signal when the variable phase signal is applied to one of the plurality of driving electrodes. The signal conversion circuit unit may be configured to detect the touch signal modulated using the variable phase signal and output the touch signal in the form of a voltage signal. The demodulation circuit unit may be configured to demodulate the signal output from the signal conversion circuit unit using the variable phase signal. The accumulator may be configured to accumulate and output the signal output from the demodulation circuit unit 500.

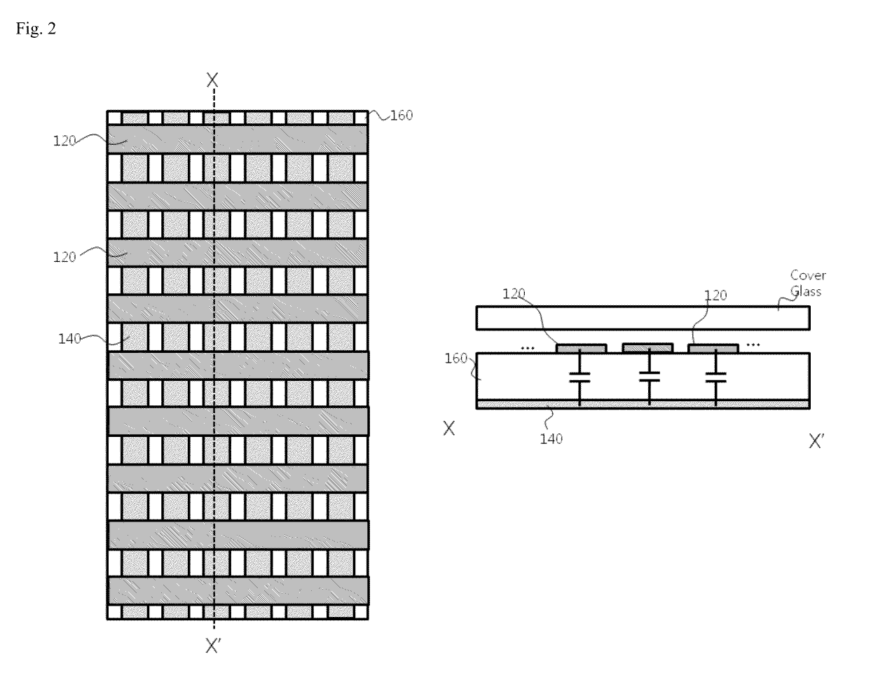

FIG. 2 is a schematic view illustrating the touch panel 100. Referring to FIGS. 1 and 2, the touch panel 100 includes sensing electrodes 120, driving electrodes 140 and a substrate 160. As an exemplary embodiment of the present invention, the substrate 160 is formed of a transparent dielectric substance, and a cover glass that allows an image represented by a display device, such as a liquid crystal display (LCD) or an active matrix organic light emitting diode (AMOLED) that may be disposed at a rear side of the substrate 160, to pass therethrough is formed on an upper surface of the substrate 160. For example, the substrate may be formed of glass. The sensing electrodes 120 and the driving electrodes 140 are all formed of a transparent material that allows an image to pass therethrough while serving to detect an object. As another exemplary embodiment of the present invention, the substrate 160 may be formed of a non-transparent material only to detect a touch by an object O.

In this specification, an object that applies a user's input to a touch panel is defined as ‘an object.’ The object represents an object that applies a touch input to the touch panel 100 by shutting an electric field flux formed between a first electrode and a second electrode, for example, a hand, a finger, a palm or a stylus. However, such an implementation of the object is illustrated as an example, and does not limit the scope of the object. For example, the object may be a cheek or toe of a user rather than the hand, finger, palm or stylus.

The plurality of sensing electrodes 120 arranged to extend in a first direction are disposed on the upper surface of the substrate 160. The plurality of driving electrodes 140 arranged to extend in a second direction perpendicular to the first direction are disposed on a lower surface of the substrate 160. The driving electrodes 140 form mutual capacitors together with the sensing electrodes 120. As an exemplary embodiment of the present invention, the driving electrodes 140 and the sensing electrodes 120 are formed of a transparent conductive material that allows an image represented by the display device disposed at a rear side of the substrate to pass therethrough. For example, the driving electrodes 140 and the sensing electrodes 120 may be formed of a transparent conductive material, such as indium tin oxide (ITO), indium zinc oxide (IZO), aluminum zinc oxide (AZO), and indium cadmium oxide (ICO). As another exemplary embodiment of the present invention, the driving electrodes 140 and the sensing electrodes 120 may be formed of carbon nanotubes (CNTs). CNTs may pass a higher current density than the transparent conductive material, such as ITO.

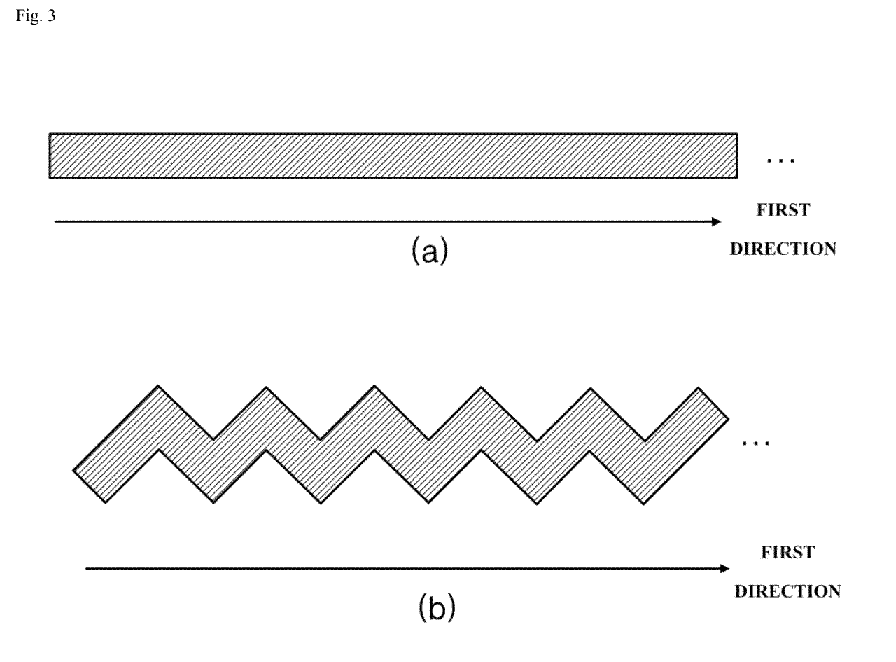

In this specification, when an element is referred to as extending in a first direction, the element may be formed in a linear manner in the first direction as shown in (a) of FIG. 3, or may be formed in a zig-zag manner in the first direction as shown in (b) of FIG. 3. Although not shown, when an element is referred to as extending in a first direction, it may be understood that the element is formed as a wavy curve in the first direction.

The sensing electrodes 120 sense a signal formed by a touch of an object, and applies the signal to the signal conversion circuit unit 200. The signal conversion circuit unit 200 includes a charge amplifier, and the charge amplifier includes an operational amplifier provided with an inverting input electrically connected to the touch panel 100, a non-inverting input electrically connected to a ground potential, and an output electrically connected to the inverting input to feed an output back to the inverting input. A resistor (R) and a capacitor (C) are electrically connected to a feedback path leading from the output to the inverting input of the operational amplifier. A potential of the sensing electrode 120 is electrically connected to the inverting input of the charge amplifier, and according to a virtual short of the operational amplifier, maintained identical to the potential of the non-inverting input. Accordingly, the current signal is converted into a voltage signal by the capacitor (C) on the feedback path, and then output.

The signal source 300 generates a variable phase signal including a reference phase signal and an out-of-phase signal that is out of phase with the reference phase signal, and applies the variable phase signal to the touch panel 100 and a delay compensator unit 400. Hereinafter, the signal which is out of phase with the referenced phase signal will be referred to as an out-of-phase signal. As an exemplary embodiment, the signal source 300 includes a signal generator unit 320 that outputs an electric signal having a single frequency. The signal generator unit 320 forms a signal having a constant frequency, and applies the signal to a phase shifter 340 and a phase mixer 360. For example, the signal generator unit 320 forms a square pulse having a predetermined frequency, and applies the square pulse to the phase shifter 340 and the phase mixer 360. For example, the signal generator unit 320 forms a sinusoidal pulse having a predetermined frequency, and applies the sinusoidal pulse to the phase shifter 340 and the phase mixer 360. For example, the signal generator unit 320 forms an electric signal including at least one of a step pulse, a square pulse, a sinusoidal pulse, a triangular pulse and a linear superposition thereof, and applies the electric signal to the phase shifter 340 and the phase mixer 360.

The phase shifter 340 receives a signal output from the signal generator unit 320, and shifts a phase of the signal by a predetermined angle. For example, when a signal applied by the signal generator unit 320 is V₁ cos(ωt), and the phase shifter 340 shifts the phase of the signal 180 degrees, the phase shifter 340 provides an output. V₁ cos(ωt+180)=−V₁ cos(ωt). The phase shifter 340 may output a signal that is out of phase with a signal output from the signal generator unit 320 by adjusting a phase angle desired for shift. For example, when a signal applied by the signal generator unit 320 is a square pulse having a high state and a low state that alternate, the phase shifter 340 outputs a signal having a high state and a low state inverted with respect to the signal applied by the signal generator unit 320, thereby outputting an out-of-phase signal having a phase difference of 180 degrees from the output signal of the signal generator unit 320.

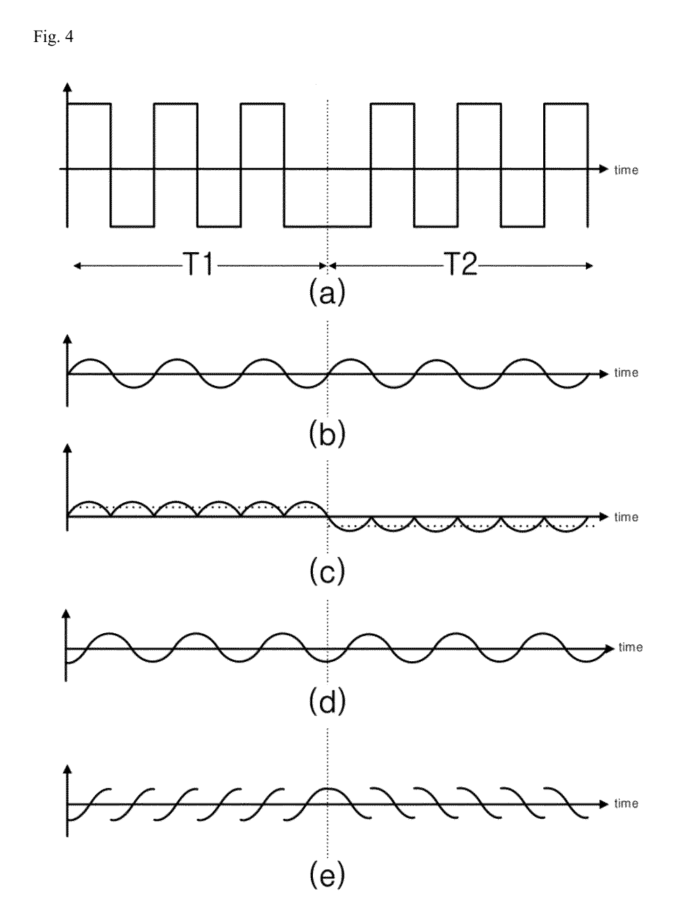

The phase mixer 360 receives the signal output by the signal generator unit 320 and the signal output by the phase shifter 340, generates an electric signal including a reference phase signal and an out-of-phase signal, and outputs the generated electric signal to the touch panel 100 and the delay compensator unit 400. A signal transmitted by a transmitter unit 380 is a variable phase signal in which a signal during a time interval T1 and a signal during a time interval T2 have a phase difference of 180 degrees as shown in (a) of FIG. 4.

The delay compensator unit 400 delays a signal applied by the signal source 300 by a time period from the point in time at which the signal is applied to the touch panel 100 by the signal source 300 until the point in time at which the signal is input into the demodulation circuit unit 500. When the signal source 300 applies a variable phase signal to the touch panel 100, the variable phase signal is delayed by a predetermined period of time by an RC delay due to resistance components and parasitic capacitance components on a signal transmission path and a capacitance formed between the driving electrode 120 and the sensing electrode 120 of the touch panel 100, and also delayed by a predetermined period of time in the process of converting a current signal, which is output by the touch panel 100 to a signal conversion circuit unit 200, into a voltage signal, and then input into the demodulation circuit unit 500. Accordingly, when the demodulation circuit unit 500 demodulates a touch signal that is modulated using a non-delayed variable phase signal, since there is a phase difference between the touch signal and the non-delayed variable phase signal, a precise touch signal is not obtained through demodulation. Accordingly, the delay compensator unit 400 delays a variable phase signal received from the signal source 300 by a time period taken from a point of time when the variable phase signal is applied to the touch panel 100 to a point of time when a modulated touch signal is output to the demodulation circuit unit 500 by the signal conversion circuit unit 200, and outputs the delayed variable phase signal to the demodulation circuit unit 500.

The demodulation circuit unit 500 demodulates the touch signal that is modulated by the variable phase signal, which includes the reference phase signal and the out-of-phase signal, applied to the touch panel 100 by the signal source 300. As described above, the delay compensator unit 400 delays a signal applied to the delay compensator unit 400 by a time period ending when a variable phase signal output by the signal source 300 is applied to the demodulation circuit unit 500 after passing through the touch panel 100 and the signal conversion circuit unit 200, and outputs the delayed signal to the demodulation circuit unit 500. Accordingly, the demodulation circuit unit 500 may obtain a touch signal by performing demodulation using the same signal as the modulation signal.

The demodulated signal is accumulated by the accumulator 600, so that effects of noise are removed from the demodulated signal. As an exemplary embodiment of the present invention, the accumulator 600 may include a low pass filter (LPF) that passes only low band frequencies of the demodulated touch signal to remove noise components. As another exemplary embodiment of the present invention, the accumulator 600 includes an integrator that removes a noise signal included in the demodulated touch signal.

Hereinafter, referring to FIGS. 1 and 4, the touch detecting apparatus having the above configuration will be described. (a) of FIG. 4 illustrates a waveform of a variable phase signal generated by the signal source 300 and applied to the touch panel 100. When a signal of a time interval T1 is a reference phase signal, a signal of a time interval T2 is an out-of-phase signal. On the other hand, when a signal of a time interval T2 is a reference phase signal, a signal of a time interval T1 is an out-of-phase signal.

When the signal source 300 applies a variable phase signal to one of the driving electrodes 140 of the touch panel 100, the driving electrode 140 forms an electric field flux together with the sensing electrodes 120 that form a mutual capacitance with the driving electrode 140, and the sensing electrode 120 applies a current formed by the electric field flux to the signal conversion circuit unit 200. When an object O touches the touch panel 100, the electric field flux formed by the driving electrode 140 and the sensing electrode 120 is shunted, the electric field flux formed on the mutual capacitor by the driving electrode and the sensing electrode is changed, and such a change in the electric field flux may be modeled as a change in the capacitance C according to a change in permittivity.

When the current flowing through the capacitor is i, i is expressed as Equation 1 below.

$$i = C \frac{d V}{d t} \\ ( \begin{matrix}V is driving signal applied to the \\ driving electrode , and C is capacitance\end{matrix} ) \qquad [ Equation 1 ]$$

When a touch is performed by an object O, a change in current occurs according to a change in the capacitance described above, the sensing electrode 120 applies the changed current to the signal conversion circuit unit 200, and then the signal conversion circuit unit 200 converts the current signal into a voltage signal.

The signal formed by the object O moving on the touch panel has a range of frequencies from several hertz to several hundreds of hertz, but such a signal is modulated by the variable phase signal applied to the touch panel 100, and thus up converted into the frequency band of the variable phase signal.

Noise introduced into the touch panel 100 by the object O is applied to the signal conversion circuit unit 200 in a state of overlapping the modulated touch signal. Accordingly, if the noise has a frequency that is the same as or adjacent to a frequency of the variable phase signal, the noise is not removed through filtering, thereby causing a touch jitter in which noise exerts an influence on extracting touch coordinates and touch coordinates are changed.

The demodulation circuit unit 500, using the variable phase signal, demodulates a signal obtained by the touch signal output from the signal conversion circuit overlapping the noise. A signal used for the demodulation is a variable phase signal that is delayed by the delay compensator unit 400 by a predetermined delay time, and thus has the same phase as the signal used to modulate the low frequency touch signal that is generated by the object O. Accordingly, the touch signal generated as the object O touches the touch panel 100 or moves on the touch panel 100 is restored through the demodulation.

In the demodulation circuit unit 500, noise is also mixed using the variable phase signal that is delayed by a predetermined period of time. (b) of FIG. 4 illustrates a noise signal waveform having the same frequency as the variable phase signal and the same phase as the variable phase signal. (d) of FIG. 4 illustrates a noise signal waveform having the same frequency as the variable phase signal, but a different phase from the variable phase signal. The noise shown in (b) of FIG. 4 has no phase difference from the variable phase signal. The noise signal shown in (b) of FIG. 4 is mixed with the variable phase signal shown in (a) of FIG. 4 by the demodulation circuit unit 500, and thus down converted into a baseband. (c) of FIG. 4 shows a result of the variable phase signal shown in (a) of FIG. 4 mixed with the noise shown in (b) of FIG. 4 by the demodulation circuit unit 500. An average value of the mixing result of the reference phase signal and the noise signal of the interval T1 is calculated as a dotted line having a positive value as shown in (c) of FIG. 4. An average value of the mixing result of the out-of-phase signal and the noise signal of the interval T2 is calculated as a value having the same absolute value and an opposite polarity with respect to the calculated value of the interval T1. Accordingly, if the accumulator 600 performs low pass filtering or an integral on the calculated results, the effect of noise during the interval T1 offsets the effect of noise during the interval T2, thereby cancelling the effect of noise.

The signal shown in (d) FIG. 4 has a phase difference of 90 degrees from the variable phase signal of (a) FIG. 4. As described, the demodulation circuit unit 500 mixes the variable phase signal of (a) of FIG. 4 with the noise shown in (d) of FIG. 4. An average value of the mixing result is calculated as O as shown in (e) of FIG. 4. Accordingly, if the accumulator 600 performs low pass filtering or an integral on the calculated result, the effects of noise offset each other, thereby removing the effect of noise.

The phase of noise is hardly changed while a touch scan is performed on one of the sensing electrodes, and if noise having an almost invariant phase is mixed using a reference phase signal and an out-of-phase signal that have the same duration as each other, the effect of the noise is removed.

As described above, the phase of the variable phase signal is changed once as shown in (a) of FIG. 4 at the boundary between the interval T1 and the interval T2. In accordance with another exemplary embodiment of the present invention, a phase of the variable phase signal is divided into several intervals T1, T2, T3 and T4 so that reference phase signals are applied separately from out-of-phase signals. Accordingly, a variable phase signal having a plurality of phase changes may be applied while connected to a single driving electrode of the touch panel. However, the total duration of references phase signals is the same as that of out-of-phase signals.

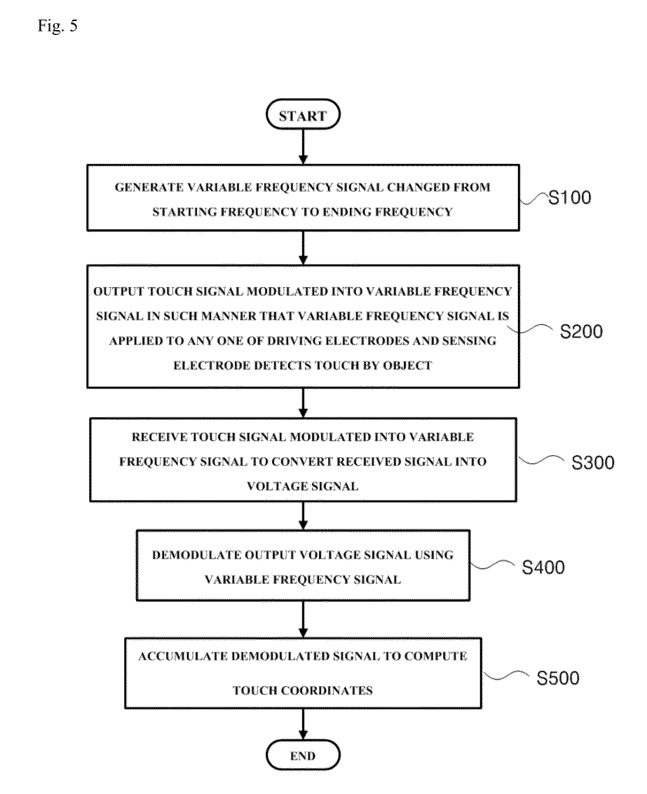

Hereinafter, a method of detecting touch in accordance with an exemplary embodiment of the present invention will be described with reference to FIG. 5. In the following description, details of parts identical to those of the previous embodiment will be omitted in order to avoid redundancy. FIG. 5 is a flowchart showing a method of detecting touch according to an exemplary embodiment of the present invention. Referring to FIG. 5, a method of detecting touch in accordance with an exemplary embodiment of the present invention includes generating a variable phase signal including a reference phase signal and an out-of-phase signal, applying the variable phase signal to a touch panel and outputting a signal modulated using the variable phase signal, detecting the signal modulated using the variable phase signal and converting the detected signal into a voltage signal, demodulating the converted voltage signal using the variable phase signal, and accumulatively calculating the demodulated voltage signal.

A variable phase signal including a reference phase signal and an out-of-phase signal is generated (S100). The variable phase signal is applied to a touch panel to modulate a signal generated when an object touches the touch panel. As an exemplary embodiment of the present invention, the frequency of the variable phase signal is constant during the time in which the variable phase signal is connected to one of the driving electrodes and applied.

The touch panel outputs a touch signal modulated using the variable phase signal (S200). A signal applied to the touch panel by a user through an object has a frequency within a baseband. Accordingly, a touch signal is formed from a baseband touch signal through modulation using a variable phase signal, and if the touch signal is demodulated using the variable phase signal, the base band touch signal is restored.

The touch panel includes driving electrodes connected to a signal source that applies a variable phase signal, and sensing electrodes connected to a signal conversion circuit unit, and the driving electrodes and the sensing electrodes form a plurality of mutual capacitances. The signal source applies a variable phase signal, which is an alternating current signal, through the driving electrode, and the sensing electrode senses a current signal that is formed by a touch from an object and modulated using the variable phase signal, and applies the current signal to a signal conversion circuit unit.

The signal modulated using the variable phase signal is detected and the detected signal is converted into a voltage signal (S300). By applying an electric current to the capacitor using a charge amplifier, a voltage corresponding to a current applied to both ends of the capacitor is formed. Accordingly, the touch signal modulated using the variable phase signal is provided in the form of a voltage signal.

The signal converted into the voltage signal is modulated using the variable phase signal (S400). Through the demodulation, the touch signal is down converted into the original frequency band. In accordance with an exemplary embodiment of the present invention, when noise introduced into a touch panel has a frequency that is identical to or adjacent to that of a variable phase signal, the noise is multiplied by a reference phase signal and an out-of-phase signal included in the variable phase signal, and is subject to an accumulative operation, such as a low pass filtering or integral operation (S500), so that the effect of noise is removed or minimized.

A reference phase signal used for the demodulation needs to have the same phase as a reference phase signal applied when a user touches the touch panel through an object. Accordingly, the reference phase signal for the demodulation represents a signal that is delayed by a time period from a point of time at which a reference phase signal is applied to the touch panel to a point of time at which the signal conversion circuit unit 200 outputs a voltage signal.

The above described exemplary embodiments can effectively prevent a touch jitter, in which touch coordinates are influenced by noise and changed, and also effectively remove the effect of noise having the same frequency (or a similar frequency) as a touch driving signal, which is not easily removed by the conventional technology.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A touch detecting apparatus comprising:
a signal source configured to generate a variable phase signal including a reference phase signal and an out-of-phase signal that is out of phase with the reference phase signal;
a touch panel including a plurality of driving electrodes and a plurality of sensing electrodes, wherein the variable phase signal is applied to one of the plurality of driving electrodes, and the sensing electrode outputs a touch signal modulated by the variable phase signal;
a demodulation circuit unit configured to demodulate the touch signal modulated by the variable phase signal using the variable phase signal; and
an accumulator configured to accumulate the demodulated touch signal to detect the touch.

2. The touch detecting apparatus of claim 1, wherein the out-of-phase signal is a signal that is 180 degrees out of phase with the reference phase signal.

3. The touch detecting apparatus of claim 1, wherein the touch detecting apparatus further comprises a signal conversion circuit unit configured to detect the touch signal modulated by the variable phase signal, and output the touch signal in the form of a voltage signal.

4. The touch detecting apparatus of claim 3, wherein the signal conversion circuit unit includes a charge amplifier, and the charge amplifier includes an operational amplifier provided with an output, an inverting input electrically connected to the touch panel, and a non-inverting input electrically connected to a predetermined electric potential, and
a resistor and a capacitor are electrically connected to a feedback path leading from the output to the inverting input of the operational amplifier.

5. The touch detecting apparatus of claim 1, further comprising a delay compensator unit configured to receive the variable phase signal from the signal source and output a delayed variable phase signal to the demodulation unit, wherein the delayed variable phase signal has a phase corresponding to a phase of the variable phase signal used in modulating the touch signal.

6. The touch detecting apparatus of claim 1, wherein the accumulator includes one of a low pass filter and an integrator.

7. The touch detecting apparatus of claim 1, wherein the reference phase signal has a total duration identical to a total duration of the out-of-phase signal.

8. The touch detecting apparatus of claim 1, wherein the variable phase signal includes an interval during which at least one reference phase signal is applied and an interval during which at least one out-of-phase signal is applied.

9. The touch detecting apparatus of claim 1, wherein a signal generated by the signal source is an electric signal including at least one of a step pulse, a square pulse, a sinusoidal pulse, a triangular pulse and a linear superposition thereof.

10. The touch detecting apparatus of claim 1, wherein the signal source includes a signal generator unit configured to form an electric signal having a constant frequency, a phase shifter configured to shift a phase of the signal output from the signal generator unit by a predetermined phase and output the phase shifted signal; a phase mixer configured to combine the electric signal output from the signal generator unit with the signal output from the phase shifter to form the variable phase signal, and a transmitter unit configured to transmit the signal formed by the phase mixer.

11. A method of detecting touch, the method comprising:
generating a variable phase signal including a reference phase signal and an out-of-phase signal that is out of phase with respect to the reference phase signal;
applying the variable phase signal to a touch panel and outputting a touch signal modulated by the variable phase signal;
demodulating the touch signal modulated by the variable phase signal using the variable phase signal; and
accumulating the demodulated touch signal to detect touch.

12. The method of claim 11, wherein the generating of the variable phase signal is performed using the reference phase signal and a signal that is 180 degrees out of phase with the reference phase signal.

13. The method of claim 11, the method further comprises converting the touch signal modulated by the variable phase signal into a voltage signal.

14. The method of claim 13, wherein the converting the touch signal modulated by variable phase signal into a voltage signal is performed using a charge amplifier.

15. The method of claim 11, wherein the demodulating of the touch signal modulated by the variable phase signal using the variable phase signal is performed by a delayed variable phase signal, wherein the delayed variable phase signal has a phase corresponding to a phase of the variable phase signal used in modulating the touch signal.

16. The method of claim 11, wherein the accumulating the demodulated touch signal is performed using a low pass filter and an integrator.

17. The method of claim 11, wherein the generating of the variable phase signal including the reference phase signal and the out-of-phase signal is performed such that a duration of the reference phase signal is identical to a duration of the out-of-phase signal.

18. The method of claim 11, wherein in the generating of the variable phase signal including the reference phase signal and the out-of-phase signal is performed such that a total duration of the reference phase signal is identical to a total duration of the out-of-phase signal.

19. The method of claim 11, wherein the generating of the variable phase signal including the reference phase signal and the out-of-phase signal is performed such that the variable phase signal at least one of a step pulse, a square pulse, a sinusoidal pulse, a triangular pulse and a linear superposition thereof.

20. The method of claim 11, wherein the generating of the variable phase signal including the reference phase signal and the out-of-phase signal comprises:
forming an electric signal having a constant frequency;
shifting a phase of the electric signal by a predetermined phase;
combining the electric signal with the signal whose phase is shifted by the predetermined phase to form a variable phase signal; and
transmitting the variable phase signal.
